(19) United States
(12) Patent Application Publication
(10) Pub. No.: US 2026/0152006 A1
(43) Pub. Date: Jun. 4, 2026

(54) LIQUID EJECTION HEAD, REPLACEMENT APPARATUS, AND PRINTING APPARATUS

(71) Applicant: CANON KABUSHIKI KAISHA, Tokyo (JP)

(72) Inventors: YOSUKE TAKAGI, Kanagawa (JP); YUJI TAMARU, Tokyo (JP); KAZUHIRO ISHII, Kanagawa (JP); HISAO OKITA, Kanagawa (JP); TOMOO IIZUMI, Kanagawa (JP)

(21) Appl. No.: 19/406,049

(22) Filed: Dec. 2, 2025

(30) Foreign Application Priority Data
Dec. 3, 2024 (JP) 2024-210170

(51) Int. Cl. B41J 2/18; B41J 2/175; B41J 2/20

(52) U.S. Cl. CPC B41J 2/18; B41J 2/17596; B41J 2/20; B41P 2251/10

(57) ABSTRACT

A liquid ejection head includes: a liquid ejection substrate having ejection elements configured to eject a liquid; a circulation pump configured to supply the liquid to the liquid ejection substrate through a supply channel and to collect the liquid from the liquid ejection substrate through a collecting channel; a pump driving circuit configured to drive the circulation pump; a first connection terminal for connecting a ground of the pump driving circuit to outside; a second connection terminal for connecting a ground of the liquid ejection substrate to the outside; a first ground wiring connecting the ground of the pump driving circuit to the first connection terminal; and a second ground wiring connecting the ground of the liquid ejection substrate to the second connection terminal. The second connection terminal and the second ground wiring are separated from the first connection terminal and the first ground wiring.

### BACKGROUND

### Field of the Technology

The present disclosure relates to a liquid ejection head configured to eject ink onto a printing medium to perform printing, as well as a replacement apparatus and a printing apparatus compatible therewith.

### Description of the Related Art

There have heretofore been proposed various printing systems equipped with liquid ejection cartridge units for printing images on printing media such as paper. For example, thermal transfer, wire dot, thermal, and inkjet printers are currently in practical use. Among these, the inkjet system has attracted attention for its low running cost and low printing noise, and is used in a wide range of fields. The inkjet system involves driving a printing element substrate included in a liquid ejection head unit to eject ink droplets from ink ejection ports formed by nozzle members on the surface of the printing element substrate. The inkjet system is an image printing method for forming an image by causing these ink droplets to land at desired positions on the paper surface. During image printing, ink is ejected by driving ejection energy generating elements disposed at positions corresponding to the ejection ports, and an image is formed by the ink landing on the printing medium. In the technical field of the recent inkjet printers, there is a demand for an ink circulation printing apparatus capable of using a special ink tailored to the printing medium, in order to output a high-quality printed product, among liquid ejection head scanning printing apparatuses. A configuration has been proposed in which an ink supply channel and an ink collecting channel are provided for circulating ink, and a circulatory flow is obtained by generating a differential pressure between the ink supply channel and the ink collecting channel. An ink circulation apparatus described in Japanese Patent Laid-Open No. 2018-30350 has a liquid ejection head unit including two reservoirs for supplying and circulating ink to an inkjet head, and a pump for conveying the ink between the reservoirs. This ink circulation apparatus also has a pressure sensor and a control circuit that drives the pump in accordance with the output from the pressure sensor, in the liquid ejection head unit.

Although not explicitly stated in Japanese Patent Laid-Open No. 2018-30350, it is common for a reference potential wiring (ground wiring) of the control circuit that drives the pump and a reference potential wiring (ground wiring) of the inkjet head that ejects the ink to be shared. This is because both are the reference potential wiring (ground wiring) for circuits provided in the same device (head). However, this configuration can cause the following issues. After the liquid ejection head is installed in the printing apparatus, a high flow rate of ink may be required in a case of filling flow channels and ejection ports with ink, or in a case of performing suction recovery to remove any air bubbles that may have formed. Furthermore, during the manufacturing process, after an ejection test is performed using test ink to confirm that there are no abnormalities, the flow channels inside the liquid ejection head unit may be cleaned and replaced with a replacement liquid such as pure water or filler ink before shipping. In such cases, a high flow rate of replacement liquid, such as a two-fluid liquid, needs to be injected to efficiently clean and replace the flow channels so that no test ink remains. In a configuration with ink circulation, such as that described in Japanese Patent Laid-Open No. 2018-30350, filling and replacement need to be performed on a complex circulation channel structure, including a subtank. To increase efficiency, it is desirable to perform filling, recovery, and replacement while driving a circulation pump. To drive the circulation pump, a drive signal for a pump driving circuit provided in the liquid ejection head unit is transmitted from the printing apparatus or manufacturing apparatus side. Furthermore, the ground (pump GND) wiring for the pump driving circuit is connected to the earth of the printing apparatus or manufacturing apparatus. Typically, inside the liquid ejection head unit, the ground (pump GND) wiring for the pump driving circuit and the ground (VSS) wiring for the liquid ejection substrate are shared (short-circuited). The ink and replacement liquid flowing into the liquid ejection elements are triboelectrically charged. This causes the liquid ejection elements to be repeatedly charged by the flowing ink or replacement liquid and then neutralized by discharging to the earth. This leads to a problem of oxidation of the surfaces of the liquid ejection elements. Oxidation of the surfaces of the liquid ejection elements can change thermal efficiency, resulting in failure to obtain normal ejection characteristics and reduced ejection durability. In a case of filling, restoring, or replacing ink in the liquid ejection head, the circulation channel structure does not provide enough efficiency for a high flow rate of liquid while driving the circulation pump, resulting in oxidation of a protective layer covering the ejection energy generating elements.

### SUMMARY

The present disclosure has been made in consideration of the above-mentioned problems, and aims to enable efficient filling recovery and replacement at a high flow rate while driving a pump and preventing oxidation of liquid ejection elements, during ink filling recovery, channel cleaning, and replacement processes for a liquid ejection head.

In an aspect of the present disclosure, there is provided a liquid ejection head comprising: a liquid ejection substrate having ejection elements configured to eject a liquid; a circulation pump configured to supply the liquid to the liquid ejection substrate through a supply channel and to collect the liquid from the liquid ejection substrate through a collecting channel; a pump driving circuit configured to drive the circulation pump; a first connection terminal configured to connect a ground of the pump driving circuit to outside; a second connection terminal configured to connect a ground of the liquid ejection substrate to the outside; a first ground wiring connecting the ground of the pump driving circuit to the first connection terminal; and a second ground wiring connecting the ground of the liquid ejection substrate to the second connection terminal, wherein the second connection terminal and the second ground wiring are separated from the first connection terminal and the first ground wiring.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view showing a schematic configuration of a printing apparatus of the present disclosure;

FIG. 1B is a block diagram showing a control system of the printing apparatus;

FIG. 2A is an exploded perspective view of a liquid ejection head of the present disclosure;

FIG. 2B is a cross-sectional view of an ejection unit of the present disclosure;

FIG. 3 is a schematic external view of an ink circulation unit of the present disclosure;

FIG. 4 is a schematic diagram of an ink circulation path of the present disclosure;

FIG. 5 is a schematic view of a pump drive wiring connections;

FIG. 6 is a schematic view of a liquid ejection head including a head electric substrate and an inkjet printing apparatus;

FIG. 7 is a schematic diagram of a replacement process;

FIGS. 8A and 8B are explanatory diagrams of protective layer oxidation during the replacement process;

FIG. 9 is an explanatory diagram of protective layer oxidation during the replacement process;

FIG. 10 is a schematic view of a liquid ejection head including a head electric substrate and a replacement apparatus;

FIG. 11 is a diagram showing a configuration for suppressing oxidation of a protective layer during a replacement process (first embodiment);

FIG. 12 is a schematic view of a liquid ejection head including a head electric substrate and a replacement apparatus according to the first embodiment;

FIG. 13 is a schematic view of the liquid ejection head including the head electric substrate and an inkjet printing apparatus according to the first embodiment; and

FIG. 14 is a schematic view of a liquid ejection head including a head electric substrate and an inkjet printing apparatus according to a second embodiment.

### DESCRIPTION OF THE EMBODIMENTS

Embodiments will be described in detail below with reference to the accompanying drawings. The following embodiments do not limit the disclosure according to the claims. While a plurality of features are described in the embodiments, not all of these features are necessarily essential to the disclosure, and the plurality of features may be combined in any desired manner. Furthermore, in the accompanying drawings, the same or similar components are denoted by the same reference numerals, and repetitive description thereof may be omitted.

While a configuration of a serial scan printing apparatus is described in the present embodiment, the present disclosure is also applicable to a liquid ejection head of full multi-head type, having nozzle arrays spanning the entire width for printing images without scanning.

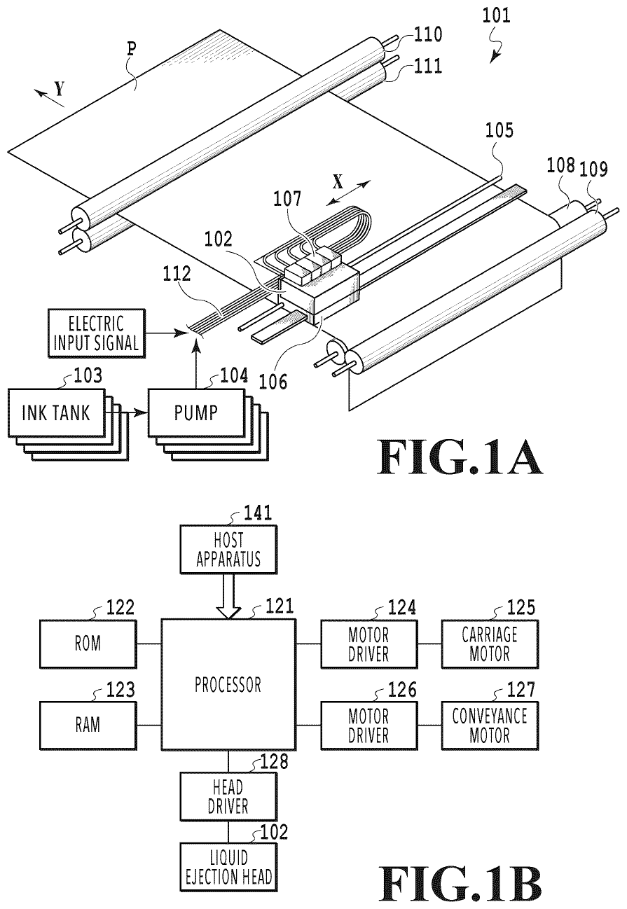

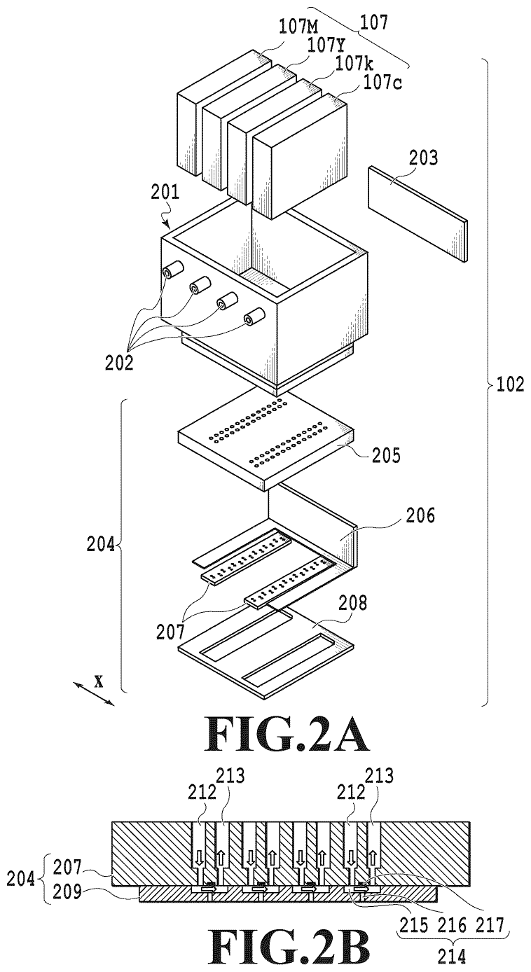

FIG. 1A is a schematic perspective view of a configuration example of a printing apparatus using a liquid ejection head 102. FIG. 1B is a block diagram of a control system of the printing apparatus. The printing apparatus of the present embodiment is a serial scan inkjet printing apparatus 101 for printing an image on a printing medium P by ejecting ink from the liquid ejection head 102. The liquid ejection head 102 is mounted on a carriage 106. The carriage 106 moves in a main scanning direction indicated by arrow X along a guide shaft 105. The printing medium P is conveyed by conveyance rollers 108, 109, 110, and 111 in a sub-scanning direction indicated by arrow Y, which intersects with (in this example, orthogonal to) the main scanning direction. The liquid ejection head 102 is equipped with an ink circulation unit 107, and ink is circulated inside an ejection unit 204 (see FIG. 2A) to be described later. An ejection energy generating element 217 (FIG. 2B) provided in the ejection unit 204 is driven by a head driver 128, in response to an input signal from a head electric substrate 203 (see FIG. 2A). Electric wiring, ink piping, and air piping required for ejection are supplied to the carriage 106 by a guide 112.

A processor 121, such as a CPU, controls the inkjet printing apparatus 101 based on a program stored in a ROM 122 that describe processing procedures and the like. A RAM 123 is used as a work area or the like for executing such processing. The processor 121 controls the head driver 128 based on image data inputted from a host apparatus 141 outside the inkjet printing apparatus 101. The processor 121 also controls a carriage motor 125 for moving the carriage 106 via a motor driver 124, and also controls a conveyance motor 127 for conveying the printing medium P via a motor driver 126.

The liquid ejection head 102 is capable of full-color printing using CMYK inks (cyan, magenta, yellow, and black). A cap member is positioned off the conveyance path of the printing medium P. In a case of performing no printing operation, the cap member moves relative to the liquid ejection head 102 to a position where the cap member covers the face surface of the liquid ejection head 102, and a suction operation is performed to avoid drying out of ejection ports and for filling recovery.

### Description of Liquid Ejection Head Configuration

FIG. 2 is an exploded perspective view showing the liquid ejection head 102 of the present embodiment. As shown in FIG. 2, the liquid ejection head 102 has the ink circulation unit 107. The circulation unit 107 includes circulation units 107m, 107y, 107k, and 107c, each corresponding to each ink. Each circulation unit 107 is connected to a channel member 201. The circulation unit 107 and the channel member 201 may be connected by screws with a sealing member sandwiched therebetween, or by welding. The channel member 201 has joints 202 for receiving the inks from the main body of the inkjet printing apparatus 101. The joints 202 are communicated so as to be connected to the respective circulation units 107m, 107y, 107k, and 107c. Upon mounting the liquid ejection head 102 to the main body of the inkjet printing apparatus 101, a supply tube (not shown) corresponding to each ink is connected to each joint 202 from the main body side of the inkjet printing apparatus 101. Each ink supplied through the supply tube is supplied to each of the circulation units 107m, 107y, 107k, and 107c through the joint 202 of the channel member 201. The ejection unit 204 is connected to the bottom surface of the channel member 201, and the ink supplied to the circulation unit 107 is supplied to the ejection unit 204 through the channel member 201. The ejection unit 204 includes: a liquid ejection substrate 207 provided with the ejection energy generating elements 217 for ejecting the ink; a support member 205; an electric wiring board 206 for sending an electric signal to the liquid ejection substrate 207; and a cover member 208 for covering the electric wiring board 206. The liquid ejection substrate 207 and the electric wiring board 206 are adhesively fixed to the support member 205. The cover member 208 is adhesively bonded to the liquid ejection substrate 207 and the electric wiring board 206 so as to cover their surfaces. The liquid ejection substrate 207 and the electric wiring board 206 are electrically connected to each other by wire bonding. Here, the electrical connection method may be flying lead bonding or the like. The cover member 208 has an opening at a location corresponding to the liquid ejection substrate 207. The ejection unit 204 and the channel member 201 may be connected by a bonding method using an adhesive, or by a fixing method using screws with a sealing member sandwiched therebetween.

The surface of the channel member 201 opposite the surface on which the joint 202 is located is a contact surface, to which the head electric substrate 203 is connected to receive electric signals from the main body. The electric signal is sent from the head electric substrate 203 to the liquid ejection substrate 207 via the electric wiring board 206 of the ejection unit 204. In this case, the head electric substrate 203 and the channel member 201 may be connected by caulking or fixing with an adhesive or double-sided tape. ACF pressure bonding is used for the electrical connection between the head electric substrate 203 and the electric wiring board 206. Wire bonding or flying lead bonding may also be used for this electrical connection.

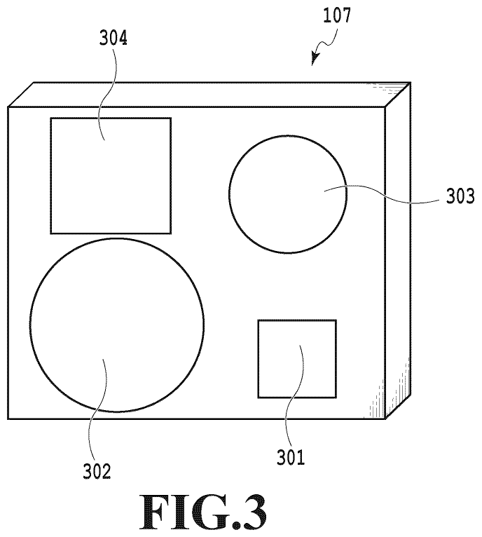

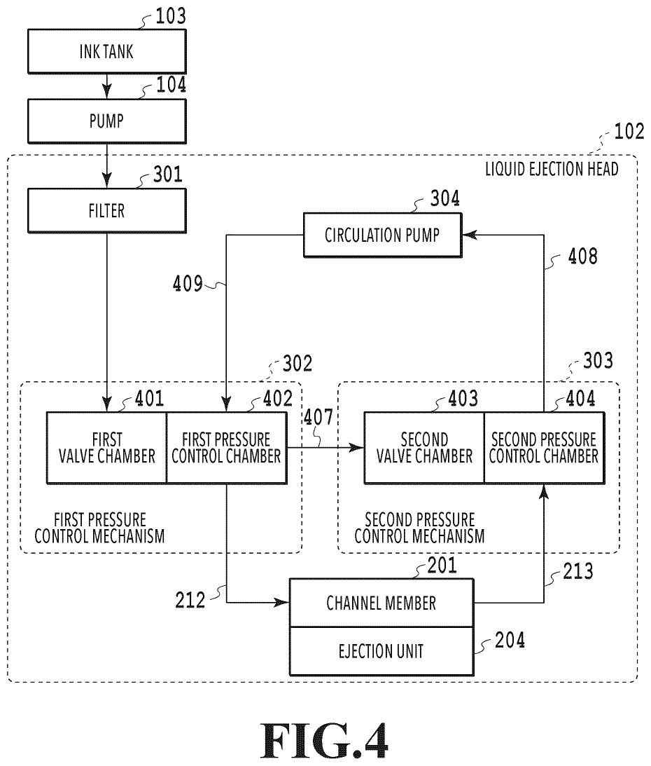

Referring to FIG. 2B, an ejection port forming member 209 is bonded to the liquid ejection substrate 207. A plurality of ejection elements 214 are formed in the ejection port forming member 209. Each of the ejection elements 214 includes a pressure chamber 215, an ejection port 216, and an ejection energy generating element 217. The pressure chamber 215 and the ejection port 216 communicate with each other. The ejection ports 216 are arranged as openings on the ejection surface. Ink supplied to a supply channel 212 from a first pressure control chamber 402 (see FIG. 4) of a first pressure control mechanism 302 (see FIG. 3) is supplied to a plurality of pressure chambers 215 formed on the liquid ejection substrate 207 of the ejection unit 204. The ink in the pressure chamber 215 is ejected from the ejection port 216 by energy outputted by the ejection energy generating element 217. The ink not ejected from the ejection port 216 is discharged from the pressure chamber 215 to a collecting channel 213, and then collected into a second pressure control chamber 404 (see FIG. 4) of a second pressure control mechanism 303 (see FIG. 3).

### Description of Circulation Path

FIG. 3 is a schematic external view of the ink circulation unit 107 applied to the inkjet printing apparatus 101 of the present embodiment. One ink circulation unit 107 is provided for each color. The ink circulation unit 107 includes the first pressure control mechanism 302, the second pressure control mechanism 303, a filter 301, and a circulation pump 304.

FIG. 4 is a schematic diagram showing a circulation path for one color applied to the inkjet printing apparatus 101 of the present embodiment. Ink is pressurized and supplied from an ink tank 103 to the liquid ejection head 102 by the pump 104. After dust is removed from the ink by the filter 301, the ink is supplied to a first valve chamber 401 of the first pressure control mechanism 302. The ink then has its pressure adjusted as it flows into the first pressure control chamber 402, which communicates with the first valve chamber 401 via a valve (not shown). The circulation pump 304 is a piezoelectric diaphragm pump that changes the volume within a pump chamber by inputting a drive voltage to a piezoelectric element attached to the diaphragm, thus causing pressure fluctuations to alternately move two check valves and send the ink. The circulation pump 304 is driven to send the ink from a downstream pump inlet channel 408 to an upstream pump outlet channel 409. By driving the circulation pump 304, the ink having its pressure adjusted in the first pressure control chamber 402 is supplied to the supply channel 212 and a bypass channel 407. A portion of the supply channel 212 is formed in the channel member 201 and connected to the ejection unit 204. A portion of the collecting channel 213 is also formed in the channel member 201 and connected to the ejection unit 204. The ink supplied to the supply channel 212 passes through the ejection element 214 formed on the liquid ejection substrate 207 of the ejection unit 204, is discharged into the collecting channel 213, and is then supplied to the pressure control chamber 404 of the second pressure control mechanism 303. As described above, the ejection element 214 includes the pressure chamber 215 and the ejection port 216. The ink supplied to a second valve chamber 403 of the second pressure control mechanism 303 is also supplied to the second pressure control chamber 404, which communicates with the second valve chamber 403 via a valve (not shown). The ink supplied to the second pressure control chamber 404 is supplied to the pump inlet channel 408, passes through the circulation pump 304, and is then supplied to the pump outlet channel 409, and then to the first pressure control chamber 402. This ink circulation by the circulation pump 304 through the ejection energy generating elements 217 disposed on the liquid ejection substrate 207 makes it possible to suppress thickening of the ejected ink. The circulation path is not limited to the configuration that passes through the ejection energy generating elements 217, but may be configured to circulate the ink within the ejection unit 204 to a degree that effectively suppresses thickening of the ink in the ejection element 214.

### Description of Circulation Pump Drive Mechanism

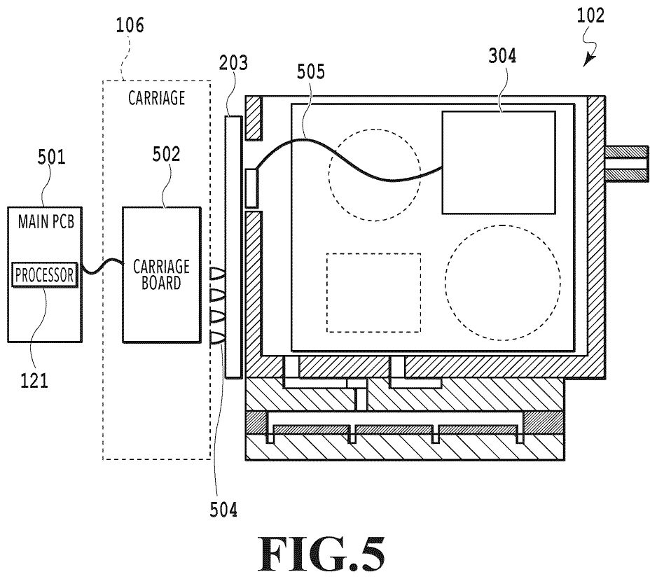

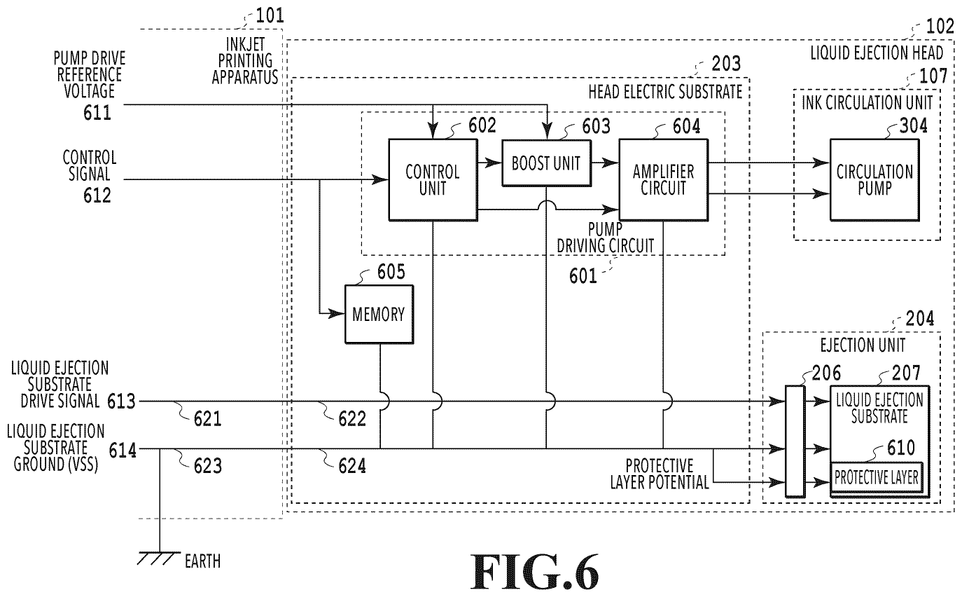

FIG. 5 is a schematic view of a mechanism for driving the circulation pump 304. A drive signal is sent from the processor 121 mounted on a main PCB 501 inside the inkjet printing apparatus 101 to a carriage board 502 via a flexible flat cable (FFC). Furthermore, a signal for driving the liquid ejection substrate 207 (see FIG. 2A) as well as a signal for controlling a pump driving circuit 601 (see FIG. 6) and a reference voltage are sent from the carriage board 502 to the head electric substrate 203 (see FIG. 2A) via an electrical connection section 504 that uses contact connection. The pump driving circuit 601 (see FIG. 6) is mounted on the head electric substrate 203. A pump drive signal outputted from the pump driving circuit 601 is outputted to the circulation pump 304 via a harness wiring 505. The circulation pump 304 is driven by the pump drive signal, thereby circulating a liquid such as the ink. The electrical connection section 504 includes connection terminals that are pins on the carriage side and connection terminals that are pads on the head electric substrate 203 side.

### Description of Head Electric Substrate and Pump Driving Circuit

FIG. 6 is a schematic view showing the overall configuration of the head electric substrate 203 and the pump driving circuit 601 provided inside the head electric substrate 203. The pump driving circuit 601 has functional units: a control unit 602, a boost unit 603, and an amplifier circuit 604. Upon receiving a pump drive reference voltage 611 and a control signal 612 from the inkjet printing apparatus 101, the control unit 602 controls the boost unit 603. The boost unit 603 then generates a pump drive voltage required to obtain a circulatory flow of liquid. The control unit 602 also controls the amplifier circuit 604. The amplifier circuit 604 then amplifies the original pump drive waveform to the voltage outputted by the boost unit 603 to generate a high-voltage pump drive signal.

In the present embodiment, the head electric substrate 203 is provided with a memory 605 that stores information and history specific to the liquid ejection head 102. The pump driving circuit 601 and the memory 605 are connected through a bus within the head electric substrate 203, and are both controlled by an I2C signal, which is the control signal 612 transmitted from the inkjet printing apparatus 101.

Meanwhile, a liquid ejection substrate drive signal 613 for driving the liquid ejection substrate 207 is transmitted from the inkjet printing apparatus 101 to the liquid ejection head 102. The liquid ejection substrate drive signal 613 is transmitted to the liquid ejection substrate 207 via the head electric substrate 203 and the electric wiring board 206. For this purpose, the inkjet printing apparatus 101 is provided with an drive signal wiring internal to the printing apparatus 621, and the head electric substrate 203 is provided with a drive signal wiring internal to the head 622. The liquid ejection substrate drive signal 613 then drives the ejection energy generating elements 217 provided on the liquid ejection substrate 207, thereby ejecting the liquid.

Here, description will be given of the ground for the various signals transmitted to the liquid ejection head 102. As mentioned above, the head electric substrate 203 is provided with the pump driving circuit 601 and the memory 605. The liquid ejection substrate drive signal 613 passes through the head electric substrate 203. In such a configuration, it is common for the ground of the pump driving circuit 601, the ground of the memory 605, and the ground corresponding to the liquid ejection substrate drive signal 613 to be shared. This is because sharing these grounds allows for a stronger ground to be provided and the number of signals to be reduced. Reducing the number of signals allows for downsizing and cost reduction of the liquid ejection head 102 and the inkjet printing apparatus 101. For this reason, in the configuration shown in FIG. 6, the grounds of the circuits included in the pump driving circuit 601, the ground of the memory 605, and the ground corresponding to the liquid ejection substrate drive signal 613 are bundled together by an ground wiring internal to the head 624 within the head electric substrate 203. The ground wiring internal to the head 624 is grounded to the earth of the inkjet printing apparatus 101 via wiring of a liquid ejection substrate ground 614 (the ground wiring internal to the printing apparatus 623) common to these grounds.

### Description of Protective layer Oxidation Issue

However, the above-described configuration with common ground wiring can sometimes cause trouble. An example of such trouble will be described below.

In a case of filling the channels and ejection ports with ink or performing suction recovery to remove any air bubbles that may have formed, after the liquid ejection head 102 is mounted on the inkjet printing apparatus 101, it may be necessary to flow the ink at a high flow rate through the liquid ejection head 102. Furthermore, during the manufacturing process, after an ejection test is performed using test ink to confirm that there are no abnormalities, the channels inside the liquid ejection head 102 may be cleaned and replaced with a replacement liquid such as pure water or filler ink before shipping. In this case, to efficiently clean and replace the channels without leaving any test ink residue, the replacement liquid such as a two-fluid liquid needs to be injected at a high flow rate.

In a case of the configuration with ink circulation as in Japanese Patent Laid-Open No. 2018-30350, filling and replacement need to be performed on a complex circulation channel structure including a subtank. To increase efficiency, it is desirable to perform filling recovery and replacement while driving the circulation pump.

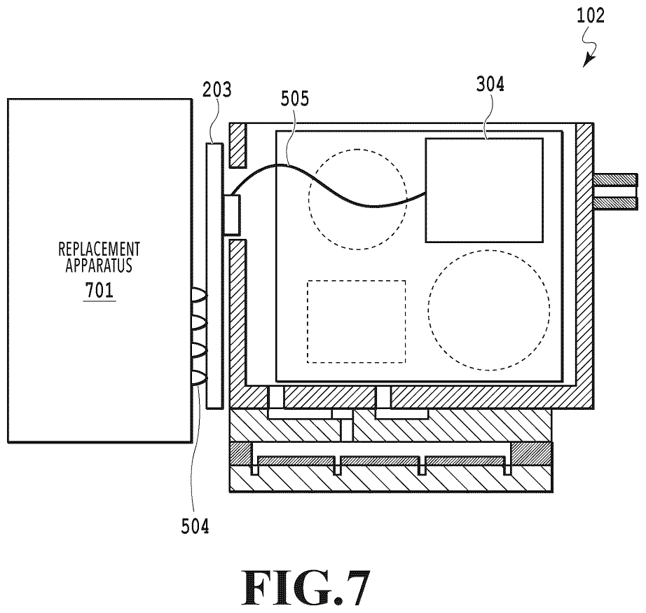

FIG. 7 is a schematic diagram showing a configuration for performing ink replacement in a manufacturing process, representing one such example.

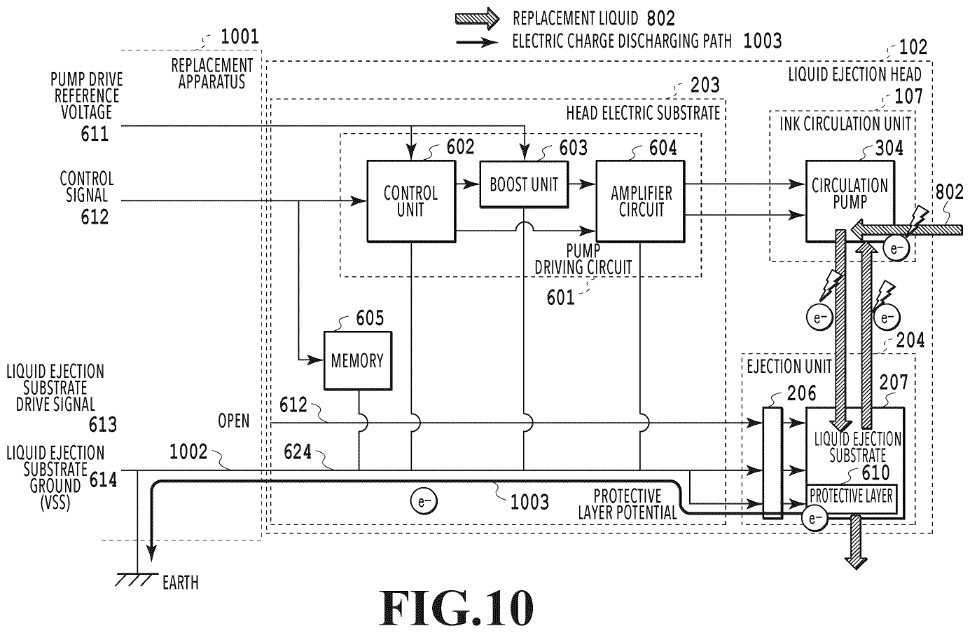

A two-fluid replacement liquid 802, a mixture of pure water and air, is supplied to the liquid ejection head 102 at a high flow rate from a replacement apparatus 1001 (see FIG. 10) connected to the inkjet printing apparatus 101 via the joint 202. A shipping inspection ink and the replacement liquid 802 are then sucked from the ejection port 216 side of the liquid ejection substrate 207 and discharged from the ejection port 216. In this case, a configuration with a circulation channel as in the present embodiment has difficulty in replacing the ink with the replacement liquid 802, particularly in a channel on the collection side, resulting in poor efficiency. To solve this problem, the replacement apparatus 1001 is electrically connected to the head electric substrate 203. The replacement apparatus 1001 then supplies the pump drive reference voltage 611 and the control signal 612 to the head electric substrate 203. The ground of the liquid ejection substrate 207 is grounded to the earth of the replacement apparatus 1001 via the wiring of the liquid ejection substrate ground 614 (common ground wiring). A replacement operation is then performed while driving the circulation pump 304 to circulate the ink. This enables highly efficient replacement within the channel while obtaining a circulatory flow including the collecting channel.

As with the above-described configuration, the grounds of the respective circuits included in the pump driving circuit 601, the ground of the memory 605, and the ground corresponding to the liquid ejection substrate drive signal 613 are bundled within the head electric substrate 203. These grounds are then grounded to the earth of the replacement apparatus 1001 via the wiring of the liquid ejection substrate ground 614 (the ground wiring internal to the head 624) common to these grounds and a ground wiring internal to the replacement apparatus 1002.

However, performing replacement while driving the circulation pump 304 can cause the following problem.

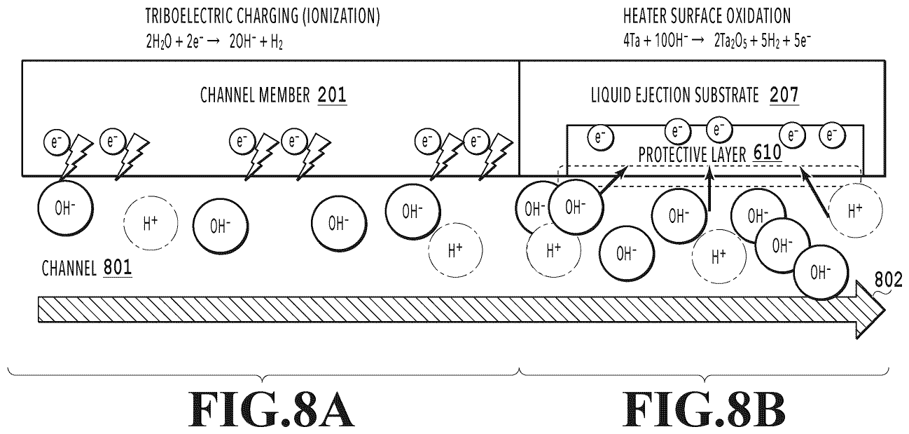

FIGS. 8A and 8B are schematic diagrams showing the problem.

During the replacement process, as the replacement liquid 802 such as pure water is introduced at a high flow rate, charging occurs due to friction against the wall surface of a channel 801. Here, the wall surface of the channel 801 refers to, for example, the wall surface of a channel provided in the channel member 201 as shown in FIG. 8A. The channel 801 includes the supply channel 212 and the collecting channel 213.

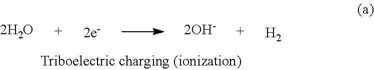

As shown in FIG. 8A, electric charges e⁻, H⁺ ions, and OH⁻ ions generated by triboelectric charging move into the liquid ejection substrate 207 downstream of the channel 801 and reach the ejection energy generating element 217. The ejection energy generating element 217 has its surface in the ejection direction covered with a protective layer 610 made of Ta or the like. As the replacement liquid 802 ionized as shown in FIG. 8A reaches the protective layer 610, the replacement liquid 802 may absorb the electric charges e⁻ and OH⁻ ions and oxidize the surface of the protective layer 610. In other words, Ta₂O₅ may be generated on the surface of the protective layer 610 (see FIG. 8B).

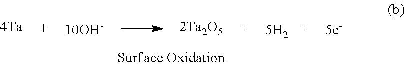

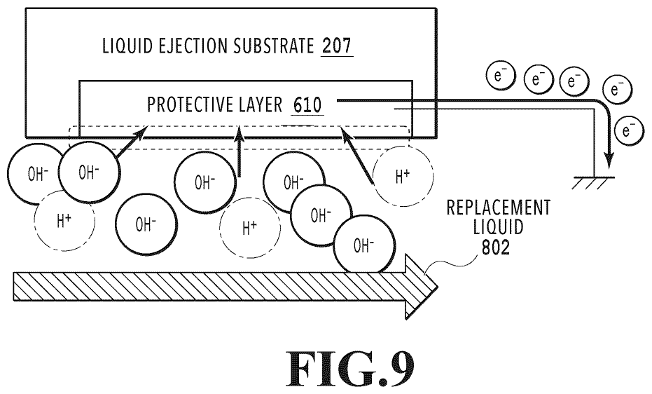

FIG. 9 shows a case where replacement is performed with the protective layer 610 earthed to the ground. The protective layer 610 is structurally and electrically in contact with the liquid ejection substrate 207. In other words, the protective layer 610 is electrically short-circuited to the liquid ejection substrate 207. Therefore, in a case where the liquid ejection substrate 207 is earthed to the ground, the protective layer 610 is also earthed to the ground via the liquid ejection substrate 207. In a case where the protective layer 610 is earthed to the ground upon receiving the electric charges e⁻ from the replacement liquid 802 ionized by triboelectric charging, OH⁻ ions are absorbed, oxidizing the surface of the protective layer 610 and dissipating the electric charges to the ground. Then, the same phenomenon is repeated as newly ionized replacement liquid 802 is supplied. This repeated charging and discharging of electric charges accelerates the oxidation of the surface of the protective layer 610, increasing the possibility of significantly affecting the ejection performance and durability.

FIG. 10 is an electrical configuration diagram in a case where the protective layer 610 is grounded during the replacement process.

As mentioned above, it is common that the grounds are shared as much as possible. Therefore, the grounds corresponding to the pump driving circuit 601, the memory 605, and the liquid ejection substrate drive signal 613 are bundled together by the ground wiring internal to the head 624 within the head electric substrate 203. The liquid ejection substrate ground 614 wiring (ground wiring internal to the replacement apparatus 1002) connected to the ground wiring internal to the head 624 is grounded to the earth of the replacement apparatus 1001. The replacement apparatus 1001 then transmits the pump drive voltage 611 and the control signal 612 to drive the circulation pump 304. The protective layer 610 within the liquid ejection substrate 207 is also bundled together by the ground wiring internal to the head 624 within the head electric substrate 203. As described above, the liquid ejection substrate ground 614 wiring (ground wiring internal to the replacement apparatus 1002) connected to the ground wiring internal to the head 624 is grounded to the earth of the replacement apparatus 1001. This configuration suppresses damage to the ejection energy generating elements 217 by static electricity during the manufacturing process and during the process of mounting the liquid ejection head on the inkjet printing apparatus 101.

As replacement is performed while driving the circulation pump 304 with such a configuration, electric charges generated by triboelectric charging of the replacement liquid 802 within the channel are charged to the protective layer 610, as shown in FIG. 10. The electric charges are then discharged via the liquid ejection substrate ground 614, which is grounded to the earth by the replacement apparatus 1001. This charging and discharging operation is repeated. This can cause severe oxidation on the surface of the protective layer 610, potentially affecting ink ejection performance and ejection durability.

The problem of oxidation of the protective layer 610 during the ink replacement process has been described above. However, similar problems can also occur in a case where a high flow rate of ink is injected to improve efficiency during ink filling and filling recovery operations in the inkjet printing apparatus 101.

The configuration as a feature of the present disclosure will be described in detail below.

### First Embodiment

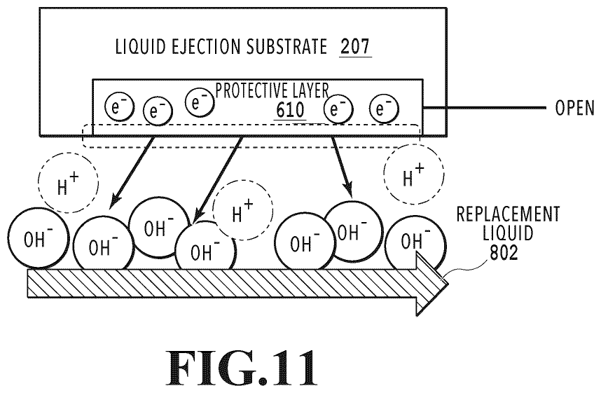

FIG. 11 is a diagram showing a configuration of the present embodiment in which a protective layer 610 is open and not grounded.

The electric charges e⁻, H⁺ ions, and OH⁻ ions generated by triboelectric charging move into a liquid ejection substrate 207 downstream of a channel 801, and reach an ejection energy generating element 217, as in the example shown in FIG. 8. However, in the case where the protective layer 610 is open, the accumulated charges are not discharged, and thus the protective layer 610 is not charged more than its capacity. Instead, a certain amount of accumulated charges repels OH⁻ ions that are subsequently supplied. This effectively suppresses surface oxidation of the protective layer 610.

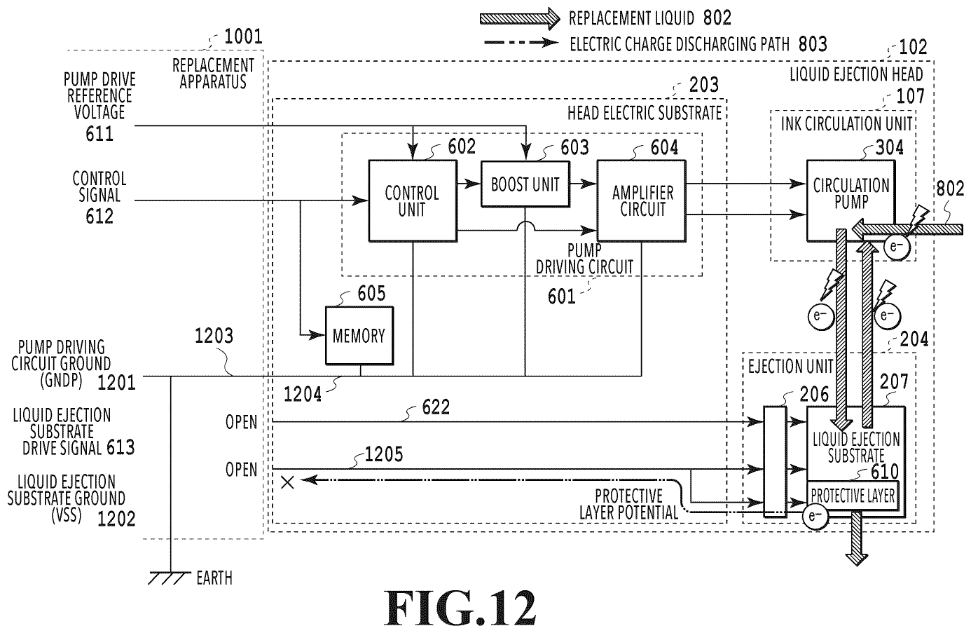

FIG. 12 is an electrical configuration diagram in a case where the protective layer 610 is open, taking an ink replacement process as a typical example.

In the configuration of the present embodiment, the ground wiring is modified as follows to maintain the protective layer 610 in a floating state while driving the circulation pump 304 during the ink replacement process. Specifically, in the configuration of the present embodiment, a pump ground wiring internal to the head (also referred to as “first ground wiring”) 1204 and a substrate ground wiring internal to the head (also referred to as “second ground wiring”) 1205 are separately provided. The ground of the pump driving circuit 601 and the ground of the memory 605 are connected to the pump ground wiring internal to the head 1204, and the protective layer 610 is connected to the substrate ground wiring internal to the head 1205. In a case where the liquid ejection head 102 is connected to the replacement apparatus 1001, the pump ground wiring internal to the head 1204 is connected to a pump ground wiring internal to the replacement apparatus 1203 provided in the replacement apparatus 1001, and the substrate ground wiring internal to the head 1205 is left open. Accordingly, the pump driving circuit 601 and the memory 605 are grounded to the earth of the replacement apparatus 1001 via the pump ground wiring internal to the head 1204 and the pump ground wiring internal to the replacement apparatus 1203. Meanwhile, the protective layer 610 is in a floating state. A pump drive reference voltage 611 and a control signal 612 are supplied from the replacement apparatus 1001 to the pump driving circuit 601.

With this configuration, replacement can be performed with the protective layer 610 in the open state while driving the circulation pump 304 with the pump driving circuit ground 1201 grounded to the earth via the replacement apparatus 1001. Therefore, this configuration can suppress oxidation of the protective layer 610 during the replacement process.

Within the head electric substrate 203, the substrate ground wiring internal to the head 1205, which corresponds to the ground 1202 of the liquid ejection substrate 207, and the pump ground wiring internal to the head 1204, which corresponds to the ground 1201 of the pump driving circuit 601, are independent of each other. To ensure insulation between two types of grounds within the substrate, it is preferable that the capacitance between the ground 1202 of the liquid ejection substrate 207 and the ground 1201 of the pump driving circuit 601 is set to less than or equal to 300 pF. In other words, it is preferable that the capacitance between the substrate ground wiring internal to the head 1205 and the pump ground wiring internal to the head 1204 is set to less than or equal to 300 pF. Accordingly, it is preferable that the distance between the substrate ground wiring internal to the head 1205 and the pump ground wiring internal to the head 1204 is set to more than or equal to 0.1 mm.

The configuration of the present embodiment is not limited to thermal-type ejection energy generating elements 217 that eject a liquid by generating heat, but is also applicable to piezoelectric-type ejection energy generating elements 217 that eject a liquid by displacement of piezoelectric elements, and the above-mentioned problems are resolved in either case.

Furthermore, while the present embodiment employs the configuration in which the pump driving circuit 601 and the memory 605 are mounted within the head electric substrate 203 included in the liquid ejection head 102, the electronic circuits and electronic components to be mounted are not limited thereto. The key point is that the ground 1202 of the liquid ejection substrate 207 and the ground 1201 of the pump driving circuit 601 are not short-circuited. In other words, the pump ground wiring internal to the head 1204 and the substrate ground wiring internal to the head 1205 are not short-circuited. If other electronic components or electronic circuits are mounted, separate grounds may be provided. However, for further downsizing of the inkjet printing apparatus 101, it is preferable to share one of the two types of grounds for the other electronic components to be mounted. However, sharing the ground is not necessarily required. Specifically, the grounds of the other electronic components may be separated from the above-mentioned two types of grounds. In other words, one or more third ground wirings different from the wirings for the above-mentioned two types of grounds may be provided, and the grounds of the other electronic components may be connected to one of the one or more third ground wirings.

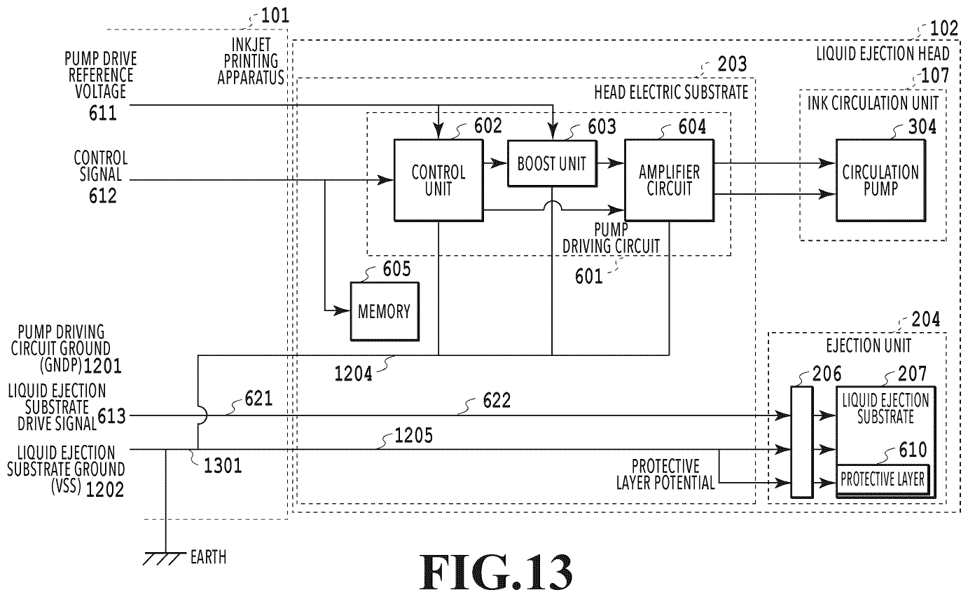

FIG. 13 is a configuration diagram showing a case where the liquid ejection head 102 having the configuration of the present embodiment is mounted on the inkjet printing apparatus 101. Under operating conditions after mounting on the inkjet printing apparatus 101, high-flow liquid supply during the replacement process is rarely performed, resulting in reduced possibility of oxidation of the protective layer 610 due to triboelectric charging within the channel. Therefore, in the present embodiment, priority is given to the effect of reducing the number of signals within the inkjet printing apparatus 101. Therefore, in the present embodiment, the inkjet printing apparatus 101 is provided with a common ground wiring internal to the printing apparatus 1301 for grounding both the pump ground wiring internal to the head 1204 and the substrate ground wiring internal to the head 1205 to the earth of the inkjet printing apparatus 101.

### Second Embodiment

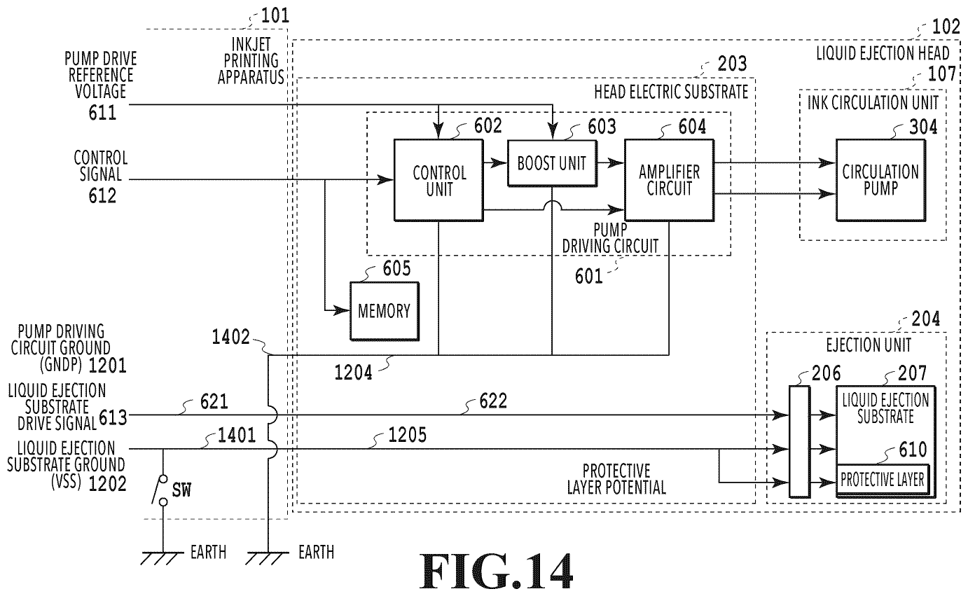

FIG. 14 is a configuration diagram showing a case where a liquid ejection head 102 is mounted on an inkjet printing apparatus 101 in a second embodiment. In the present embodiment, there is no common ground wiring internal to the printing apparatus 1301 provided for grounding both a pump ground wiring internal to the head 1204 and a substrate ground wiring internal to the head 1205 to the earth of the inkjet printing apparatus 101. Instead, in the present embodiment, there is a pump ground wiring internal to the printing apparatus 1402 provided for grounding the pump ground wiring internal to the head 1204 to the earth of the inkjet printing apparatus 101. In addition, a substrate ground wiring internal to the printing apparatus 1401 and a switch SW are also provided for grounding the substrate ground wiring internal to the head 1205 to the earth of the inkjet printing apparatus 101 if necessary. In a case of grounding the substrate ground wiring internal to the head 1205 to the earth of the inkjet printing apparatus 101, the switch SW is set to a conducting state. To set the substrate ground wiring internal to the head 1205 to a floating state, the switch SW is set to an open state.

By adopting this configuration, oxidation of the protective layer 610 can be suppressed even if a high flow rate of ink equivalent to the flow rate in the replacement process is injected during ink filling or the like upon mounting on the inkjet printing apparatus 101. While complete isolation between the two types of grounds is desirable, the necessary effect can be achieved by providing a resistance value of more than or equal to 1 MΩ.

The two types of grounds here refer to the ground 1201 of the pump driving circuit 601 and the ground 1202 of the liquid ejection substrate 207. In the configuration of FIG. 12, the two types of grounds refer to, in terms of wiring, the pump ground wiring internal to the head 1204 and the substrate ground wiring internal to the head 1205.

In the configuration of FIG. 14, the two types of grounds are, in terms of wiring, (1) wiring obtained by combining the pump ground wiring internal to the head 1204 and the pump ground wiring internal to the printing apparatus 1402, and (2) wiring obtained by combining the substrate ground wiring internal to the head 1205 and the pump ground wiring internal to the printing apparatus 1401. In other words, the resistance between the two types of grounds is the combined resistance (parallel resistance) of the resistance between the pump ground wiring internal to the head 1204 and the substrate ground wiring internal to the head 1205 and the resistance between the pump ground wiring internal to the printing apparatus 1402 and the substrate ground wiring internal to the printing apparatus 1401. In this case, for example, the resistance between the ground wiring internal to the head 1204 and the substrate ground wiring internal to the head 1205 needs to be set to more than or equal to 2 MΩ, and the resistance between the pump ground wiring internal to the printing apparatus 1402 and the substrate ground wiring internal to the printing apparatus 1401 also needs to be set to more than or equal to 2 MΩ. However, the conditions can be relaxed, for example, by setting the resistance between the pump ground wiring internal to the head 1204 and the substrate ground wiring internal to the head 1205 to more than or equal to 1 MΩ, and the resistance between the pump ground wiring internal to the printing apparatus 1402 and the substrate ground wiring internal to the printing apparatus 1401 to more than or equal to 1 MΩ.

As described above, in the liquid ejection head 102 including the pump driving circuit 601, by independently providing the ground 1202 of the liquid ejection substrate 207 and the ground 1201 of the pump driving circuit 601, oxidation of the protective layer 610 can be suppressed even if a high flow rate of ink flows through the channel. This is an effective configuration for efficient replacement and filling operations.

In other words, during the channel cleaning and replacement process of the liquid ejection head, the ground (VSS) of the liquid ejection substrate is set in a floating state. Thus, even if the triboelectrically charged replacement liquid in the channel is supplied to the liquid ejection elements, the replacement liquid is charged to saturation and then repel the negative charges, making it possible to suppress surface oxidation of the liquid ejection elements. In other words, it is possible to provide a head capable of efficiently performing ink filling recovery, cleaning, and replacement at a high flow rate while suppressing oxidation (discoloration) of the liquid ejection elements.

According to the present disclosure, during the ink filling recovery, channel cleaning, and replacement processes for the liquid ejection head, efficient filling recovery and replacement can be performed at a high flow rate while driving the pump, and the oxidation of the liquid ejection elements can also be suppressed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-210170, filed Dec. 3, 2024, which is hereby incorporated by reference herein in its entirety.

What is claimed is:

1. A liquid ejection head comprising:
a liquid ejection substrate having ejection elements configured to eject a liquid;
a circulation pump configured to supply the liquid to the liquid ejection substrate through a supply channel and to collect the liquid from the liquid ejection substrate through a collecting channel;
a pump driving circuit configured to drive the circulation pump;
a first connection terminal configured to connect a ground of the pump driving circuit to outside;
a second connection terminal configured to connect a ground of the liquid ejection substrate to the outside;
a first ground wiring connecting the ground of the pump driving circuit to the first connection terminal; and
a second ground wiring connecting the ground of the liquid ejection substrate to the second connection terminal, wherein
the second connection terminal and the second ground wiring are separated from the first connection terminal and the first ground wiring.

2. The liquid ejection head according to claim 1, wherein a protective layer covering the ejection elements is electrically short-circuited to the liquid ejection substrate.

3. The liquid ejection head according to claim 1, wherein a resistance between the second connection terminal and the second ground wiring and a resistance between the first connection terminal and the first ground wiring are more than or equal to 1 MΩ.

4. The liquid ejection head according to claim 1, further comprising:
a head electric substrate on which the pump driving circuit is mounted;
a signal wiring configured to transmit a liquid ejection substrate drive signal that is a signal for driving the ejection elements of the liquid ejection substrate, from the outside to the ejection elements; and
a signal wiring configured to transmit a control signal that is a signal for driving the pump driving circuit, from the outside to the pump driving circuit.

5. The liquid ejection head according to claim 1, further comprising:
one or more other electronic circuits or electronic components, wherein
a ground of the one or more other electronic circuits or the electronic components is connected to any one of the first ground wiring and the second ground wiring.

6. The liquid ejection head according to claim 1, further comprising:
one or more other electronic circuits or electronic components, wherein
a ground of each of the one or more other electronic circuits or the electronic circuits is connected to a ground wiring different from both the first ground wiring and the second ground wiring.

7. The liquid ejection head according to claim 1, wherein a capacitance between the first ground wiring and the second ground wiring is less than or equal to 300 pF.

8. The liquid ejection head according to claim 1, wherein a distance between the first ground wiring and the second ground wiring is more than or equal to 0.1 mm.

9. A replacement apparatus for performing liquid filling or liquid filling recovery of a liquid ejection head,
the liquid ejection head comprising:
a liquid ejection substrate having ejection elements configured to eject a liquid;
a circulation pump configured to supply the liquid to the liquid ejection substrate through a supply channel and to collect the liquid from the liquid ejection substrate through a collecting channel;
a pump driving circuit configured to drive the circulation pump;
a first connection terminal for connecting a ground of the pump driving circuit to outside;
a second connection terminal for connecting a ground of the liquid ejection substrate to the outside;
a first ground wiring connecting the ground of the pump driving circuit to the first connection terminal; and
a second ground wiring connecting the ground of the liquid ejection substrate to the second connection terminal, wherein
the second connection terminal and the second ground wiring are separated from the first connection terminal and the first ground wiring, wherein
the replacement apparatus comprises
a unit configured to cause the pump driving circuit to drive the circulation pump with the second connection terminal set in an open state and the first connection terminal grounded.

10. A printing apparatus for performing printing using a liquid ejection head and performing liquid filling or liquid filling recovery on the liquid ejection head,
the liquid ejection head comprising:
a liquid ejection substrate having ejection elements configured to eject a liquid;
a circulation pump configured to supply the liquid to the liquid ejection substrate through a supply channel and to collect the liquid from the liquid ejection substrate through a collecting channel;
a pump driving circuit configured to drive the circulation pump;
a first connection terminal for connecting a ground of the pump driving circuit to outside;
a second connection terminal for connecting a ground of the liquid ejection substrate to the outside;
a first ground wiring connecting the ground of the pump driving circuit to the first connection terminal; and
a second ground wiring connecting the ground of the liquid ejection substrate to the second connection terminal, wherein
the second connection terminal and the second ground wiring are separated from the first connection terminal and the first ground wiring, wherein
the printing apparatus comprises
a unit configured to cause the pump driving circuit to drive the circulation pump with the second connection terminal set in an open state and the first connection terminal grounded.

11. The printing apparatus according to claim 10, wherein
the liquid ejection head includes a head electric substrate on which the pump driving circuit is mounted, and
a liquid ejection substrate drive signal that is a signal for driving the ejection elements of the liquid ejection substrate, and a control signal that is a signal for driving the pump driving circuit are transmitted from the printing apparatus to the head electric substrate.

12. A printing apparatus for performing printing using a liquid ejection head,
the liquid ejection head comprising:
a liquid ejection substrate having ejection elements configured to eject a liquid;
a circulation pump configured to supply the liquid to the liquid ejection substrate through a supply channel and to collect the liquid from the liquid ejection substrate through a collecting channel;
a pump driving circuit configured to drive the circulation pump;
a first connection terminal for connecting a ground of the pump driving circuit to outside;
a second connection terminal for connecting a ground of the liquid ejection substrate to the outside;
a first ground wiring connecting the ground of the pump driving circuit to the first connection terminal; and
a second ground wiring connecting the ground of the liquid ejection substrate to the second connection terminal, wherein
the second connection terminal and the second ground wiring are separated from the first connection terminal and the first ground wiring, wherein
the printing apparatus includes a unit configured to commonly ground the first connection terminal and the second connection terminal.

13. A printing apparatus for performing printing using a liquid ejection head,
the liquid ejection head comprising:
a liquid ejection substrate having ejection elements configured to eject a liquid;
a circulation pump configured to supply the liquid to the liquid ejection substrate through a supply channel and to collect the liquid from the liquid ejection substrate through a collecting channel;
a pump driving circuit configured to drive the circulation pump;
a first connection terminal for connecting a ground of the pump driving circuit to outside;
a second connection terminal for connecting a ground of the liquid ejection substrate to the outside;
a first ground wiring connecting the ground of the pump driving circuit to the first connection terminal; and
a second ground wiring connecting the ground of the liquid ejection substrate to the second connection terminal, wherein
the second connection terminal and the second ground wiring are separated from the first connection terminal and the first ground wiring, wherein
the printing apparatus includes
a first grounding unit configured to ground the first connection terminal;
a second grounding unit configured to ground the second connection terminal via a switch, wherein
in a case where the switch is in a conducting state, the second connection terminal is grounded, and
in a case where the switch is in an open state, the second connection terminal is in an open state.

14. The printing apparatus according to claim 13, wherein a resistance value between the first grounding unit and the second grounding unit is more than or equal to 1 MΩ.
